(19) United States
(12) Patent Application Publication
(10) Pub. No.: US 2017/0114294 A1
(43) Pub. Date: Apr. 27, 2017

(54) DEVICE FOR THE REMOVAL AND SEPARATION OF HELIUM ISOTOPES FROM NATURAL GAS

(71) Applicant: INVAP S.E., Provincia de Rio Negro (AR)

(72) Inventors: Pablo FLORIDO, Provincia de Rio Negro (AR); Rodolfo CARLEVARIS, Provincia de Rio Negro (AR); Eduardo D'AMATO, Provincia de Rio Negro (AR)

(21) Appl. No.: 15/293,646

(22) Filed: Oct. 14, 2016

(30) Foreign Application Priority Data
Oct. 21, 2015 (AR) AR P2015 01 03410

(51) Int. Cl. C10L 3/10; B01D 53/22; C01B 23/00; B01D 59/12

(52) U.S. Cl. CPC C10L 3/101; B01D 59/12; B01D 53/226; C01B 23/0042; C01B 2210/0031; C01B 2210/001; C10L 2290/548

(57) ABSTRACT

This disclosure presents a new device for the removal and separation of isotopes of Helium in Compressed Natural Gas, based on a system with two cascades operating together to increase, in the first cascade, the concentration of Helium in the cascade head, and at the tail of the same cascade, Helium-depleted Compressed Natural Gas is discharged, while the second cascade, fed from the head of the first cascade, allows separation of the isotopes of Helium-3 and Helium-4, discharging Helium-3 through the head of the second cascade, while Helium-4 is discharged through the tail of the second cascade, with a configuration that is efficient from the energy consumption standpoint, while using a small number of rotating parts.

### CLAIM OF PRIORITY

This application claims priority to Argentinian Patent Application AR P2015 01 03410 filed on Oct. 21, 2015, the entirety of which is incorporated by reference herein.

### FIELD OF THE DISCLOSURE

The disclosure relates to a DEVICE FOR THE REMOVAL AND SEPARATION OF HELIUM ISOTOPES FROM NATURAL GAS, specifically created to separate helium isotopes in Natural Gas.

More particularly, this disclosure relates to a device for the production of higher purity Natural Gas by removing the Helium that is usually present in Natural Gas, as well as separating Helium isotopes from each other in the device itself by combining polymeric and porous membranes with a high efficiency streams design and simplified components.

### BACKGROUND OF THE DISCLOSURE

The main source of Helium is Natural Gas, where Helium can be found in concentrations of up to 10% by volume. Usually, sources of Natural Gas with concentrations above 0.1% by volume are taken as the limit for the extraction of Helium from Natural Gas.

There is currently increasing interest in boosting the production of Helium because the world demand is still increasing and current production levels makes it hard to obtain the amounts required.

As stated by Rufford et al. in their review of the state of the art for the extraction of Helium from Natural Gas in 2014, commercial plants recently constructed or in development all use cryogenic distillation to perform the separation of Helium from Natural Gas.

Considering that cryogenic distillation plants are expensive and complex, and are only justified if they are auxiliary plants to the production of Liquefied Gas, there are currently other methods under investigation to extract Helium from Natural Gas directly and without liquefaction, like a pilot facility using Pressure Swing Adsorption (PSA) detailed by Das et al. in 2012.

There are also patents with modifications to the PSA method, like the one proposed by D'Amico et al. in 1996, or that proposed by Baksh in 2010 to use Temperature Swing Adsorption (TSA).

The challenge of PSA and TSA methods and its various combinations is that in order to compete with cryogenic distillation at a commercial scale, there is always the disadvantage that since Helium is an inert gas, the absorption mechanism would necessitate the removal by adsorption of the large quantities of Natural Gas in Helium, as is clearly explained in the proposal by Stern et al. of 1959.

This is why there are also proposals for combinations of methods, such as that proposed by Stonner in 1997, where the disclosure patent states that the purpose is to lower the costs of large volumes of adsorbent materials, feeding a stream of PSA with a feed flow resulting from previous Helium-enrichment, and therefore a reduction in the flow of Natural Gas, achieved using a membrane separation unit, where the fraction of Helium selectively permeates in relation to the carrier gas, in this case Natural Gas.

This higher permeability of Helium has produced, up to this date, a large number of proposals to separate Helium and other gasses in Natural Gas through different configurations for the connection of cascades of membranes diffusors, after the first Helium separation cascade with membranes proposed, such as that proposed by Stern in 1959.

With the improvements of polymeric membranes, both rubbery polymers and glassy polymers, depending on whether these operate at a temperature higher or lower than the temperature for vitrification of the material of the membranes, the development of mechanical configurations with large quantities of very small parallel fibers inside the same unit, and the manufacturing of each fiber as a small separating layer deposited on a very high-permeability porous structure, as detailed in the reviews by Baker in the year 2002, Baker et al. in the year 2008, and Bernardo et al. in the year 2009, polymeric membranes have started being used for commercial purposes for the separation of CO2 from Natural Gas since approximately 1990.

These membranes, depending on whether they are rubbery or glassy polymers, separate gasses according to the different speeds at which gases permeate through the membranes, due to the dissolution and diffusion mechanisms involved, for the various gasses.

These mechanisms are complex, but usually it is said that while in some cases the mechanism is controlled by the chemical affinity, in others cases the permeability mechanism is controlled by the effective diameter of the molecules of the gasses.

The separation factors obtained for this type of membranes vary according to the membranes and the gasses, but they range from a factor close to 1, where there is no difference in permeability between the two gasses, to factors above 10 or 100, where a gas can permeate through, at an equal difference of partial pressures with up to 10 or 100 times more flow than the second gas, respectively.

As described by Mohshim et al. in 2013, the advantage of alternative to inert porous membranes is that they are quite more permeable than polymeric membranes, but they are fragile, and therefore require operation at low pressures to be efficient, and their cost is very high compared to current polymeric membranes, and, in turn, reach lower separation factors than many polymeric membranes, which is why they are not used to separate gases from Natural Gas.

Porous membranes, for extremely small pores and high pressures, separate molecules according to the different effective diameters of molecules in relation to the radius of the pores, while at low pressures separate molecules according to their mean free path, when these are comparable to the radius of the pores. This means that this type of membranes can be used to separate different isotopes of one same chemical gaseous element.

For these cases where the mean free path of the gas is comparable to the pore radius, the maximum theoretical separation factor attainable between two phases is approximately the square root of the ratio of the molecular weight of the two gases, a separation factor only slightly above one for heavy isotopes, but it may be relatively high for light isotopes, such as Helium.

But, the disadvantages of using polymer membranes to separate Helium from Natural Gas are complexity and capital costs, which means that, given the low concentrations of Helium in Natural Gas, streams with various serial stages are required, as proposed by Stern in its 1959 patent, and the related complexity and costs significantly increase when cascades of just two or more stages are used, since the recycle of the not diffused stream in previous stages requires intermediate compressors to ensure compatible pressures and flow direction, in configurations that are complex, as we can see in the three stages proposal by Prasad in 1992 to separate nitrogen from air, or the two stages proposed by Daus et aL in the year 2000 to separate CO2 from Natural Gas, since they involve up to twice the number of rotating machines, with the implied disadvantages of requiring up to two sets of engines, seals, bearings, rotors and housings for each separation stage.

Other proposed alternatives, disclosed in patents, have consisted of configurations where the stream with decreasing pressures on the non-diffused side, to ensure circulation direction, forcing the pressure lowering only on diffused sides, as we can see in the two stage proposals by Callaham in 1996 to separate CO2 or N2 from Natural Gas, or the proposal to increase feed pressure to the intermediate stage, or the three stages proposal by Malsam et al. to separate CO2 or nitrogen from Natural Gas of 2009, or the three stages proposal by Karode to separate Helium from Natural Gas in the year 2014.

These recycle management options are not convenient for large-scale recover of the low percentages of Helium in Natural Gas, since that requires more than three serial stages; some are very complex because they require double the number of rotating machines, while others force pressure points of the different phases and recycle combinations that are different from the optimal points of a stream for the separation of Helium from Natural Gas when more than two or three stages are required.

Accordingly, there is a need for a solution to extract the Helium from Compressed Natural Gas in a more affordable way than cryogenic distillation. Currently, those plants can only be applied in the more reduced market of Liquefied Natural Gas, which, despite being increasing, has a smaller niche than Compressed Natural Gas; furthermore, because Liquefaction plants are very expensive and complex, the Liquefaction process requires to consume up to 11% of the Natural Gas processed, and requires complex processes and equipments for the transfer and transportation of Liquefied Natural Gas.

In addition to these issues, the minority isotope in Helium, Helium 3, found in small concentrations, varying from one reservoir to another, found in Natural Gas in concentrations of approximately parts per million, is also undergoing a demand crisis, one even more severe than Helium. Helium 3 is currently only produced as a byproduct of Tritium production programs, which cannot produce more than a fifth or sixth of the current demand for Helium-3, as analyzed by Arkharov et al. in 2013. This is why, as proposed by Bentoumi et al. in 2013, or analyzed by S. Newbury in 2012, several alternatives to obtain Helium 3 are being analyzed, sometimes including separation of Helium-3 from the Helium in Natural Gas. There are currently no additional industrial systems, whether operating or under construction, to produce relevant amounts of Helium-3 from Natural Gas.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

### INCORPORATION BY REFERENCE

S. A. Stern et. al., U.S. Pat. No. 3,246,449. April 1966

R. Prassad, U.S. Pat. No. 5,102,432. April 1992

R. A. Callaham, U.S. Pat. No. 5,482,539. January 1996

J. S. D'Amico et. al., U.S. Pat. No. 5,542,966. August 1996.

G. Stonner et. al., U.S. Pat. No. 5,632,803. May 1997.

P. A. Daus, et. al., U.S. Pat. No. 6,128,919. October 2000.

M. G. Malsam, et. al., U.S. Pat. No. 7,604,681 B2. October 2009.

M. S. A. Baksh, U.S. Patent Publication 2010/0251892 A1. August 2010.

S. K. Karode, U.S. Patent Publication 2014/0243574 A1. August 2014.

T. E. Rufford, K. I. Chan, S. H. Huang, E. F. May. “A Review of Conventional and Emerging Process Technologies for the Recovery of Helium from Natural Gas”. Adsorption Science & Technology. Vol 32, No 1. 2014.

N. K. Das, P. Kumar, C. Mallik, R. K. Bhandari. “Development of a helium purification system using pressure swing adsorption”. Current Science. Vol 103, No 6. 2012.

R. W. Baker. “Future Directions of Membrane Gas Separation Technology”. Industrial & Engineering Chemistry Research. Vol 41, No 6, 2002.

R. W. Baker, K. Lokhandwala. “Natural Gas Processing with Membranes: An Overview”. Industrial & Engineering Chemistry Research. Vol 47, No 7, 2008.

P. Bernardo, E. Drioli, G. Golemme. “Membrane Gas Separation: A Review/State of the Art”. Industrial & Engineering Chemistry Research. Vol 48, No 10, 2009.

D. F. Mohshim, H. bin Mukhtar, Z. Man, R. Nasir. “Latest Development on Membrane Fabrication for Natural Gas Purification: A Review”. Journal of Engineering, Vol 2013, 2013.

A. M. Arkharov, I. A. Arkharov, D. A. Dolgopyatov, V. L. Bondarenko. “He-3 Supply Crisis: Reasons and Challenges”. Chemical and Petroleum Engineering. Vol 49. Nos 1-2, 2013.

G. Bentoumi, R. Didsbury, G. Jonkmans, L. Rodrigo, B. Sur. “Direct Harvesting of Helium-3 from Heavy Water Nuclear Reactors”. AECL Nuclear Review. July, 2013

S. Newbury. S. Cohen, C. Gentile. “Evaluation of Earth's Helium Supply”. Program on Plasma Science and Technology, Princeton University. 2012.

These references are each incorporated by reference herein.

### SUMMARY OF THE DISCLOSURE

Given the disadvantages presented above, this disclosure has been conceived to solve those issues. In other words, the purpose of this disclosure is to create a device to address the challenges of Helium production, with the necessary capacity to produce quantities that are relevant in relation to the world demand.

Another purpose of this disclosure is that the proposed device, based on the treatment of Compressed Natural Gas, and without requiring liquefaction of Natural Gas to extract the Helium found in Natural Gas, in addition also separate isotopes Helium-3 and Helium-4, as present in the Helium of Natural Gas.

For such purposes, this disclosure is directed to a new device for high pressure processing of Natural Gas from wellhead and gas pipelines and Natural Gas processing plants, operating through two coupled streams which allow separation of Helium from Natural Gas, as well as separation of the two isotopes of Helium.

To do so, the first stream at high pressure permeable membranes allows separation of Helium in Compressed Natural Gas, since both gasses have different permeability through a great variety of membrane materials, as well as other gasses which may be also present in Natural Gas, which then feeds a second coupled cascade connected to the first one, with inert porous membranes and operating at a lower pressure, which allows separation of isotopes Helium-3 from Helium-4, because from the extraction of the head of the second cascade, or area of the cascade with highest Helium-3 enrichment there is predominantly extraction of Helium-3 present in Natural Gas, while at the tail of the second cascade, or Helium-3 depleted zone of the cascade and lower enrichment of this isotope, there is predominant extraction of the Helium-4 present in Natural Gas.

Gasses that are heavier than Helium-4 can be extracted at other points of the cascade tail, while gasses that are lighter than Helium-3 can be extracted at other points of the head of the cascade.

The first cascade with polymeric membranes separates the gasses by dissolution and diffusion by typical regime of permeable membranes, and allows operation at relatively high pressures, which increases the flows for a certain amount of membrane areas.

The second cascade, feeding only from light compounds from the first cascade (mainly Helium) and due to the reduction in the flow generated by the reduced contents of these in Natural Gas, may operate at low pressures without significantly worsening the size of the stages and volumetric flows involved. By operating at low pressures, porous membranes can operate within the range in which the radius of the pores is similar to the mean free path of gasses, which is why this second cascade allows for separation of Helium-3 from Helium-4, as well as Hydrogen from Helium-3, if present in the Natural Gas fed to the device.

Since these cascades result from a greater number of stages than the two or three stages described in the prior art, and since the purpose is not to increase costs by including two compressors per stage, one first compressor to keep the flow through the permeable or porous membranes and the second compressor to feed the recycle from the subsequent stage, and to avoid the increase in energy consumption by sending recycles directly to the inlet of the compressors, the cascades in the device eliminate recycle compressors and replace them with gas-gas injectors, where the driving fluid increases speed and decreases pressure in a nozzle, to mix with the recycle fluid and recover the pressure after a zone where the two flows mix and an outlet diffuser.

That recycling with gas-gas injectors allows for elimination of recycle compressors in both cascades without requiring rotating parts, seals and motors.

Because of the high separation values that can be reached with current polymeric membranes acting as permeable membranes for Helium in relation to Natural Gas, the device can reach extraction values above 90% of Helium in Natural Gas with no depleting stage between the injection point of the feed and the extraction of the tail (Helium-depleted and methane-enriched) of the first cascade.

Due to the lower separation values that can be achieved with current porous membranes for the second cascade, such as various porous membranes currently available, these require a certain small number (typically below 10) of depletion stages between the feed and extraction point of the cascade tail to produce extraction above two thirds of the Helium-3 in Helium from Natural Gas.

Therefore, the resulting device efficiently separates Helium from Natural Gas, and also Helium-3 from Helium-4 in the Helium in Natural Gas.

Operating each stage at its optimum pressure regime, feeding with the lowest mass flows the stages requiring lower pressure, and simplifying recycles with gas-gas injectors, the set allows production with the highest separation factors and separation of the gasses present in Natural Gas, with the advantage that the feed is carried out minimizing pressure differences and temperatures in relation to those in gas pipelines and oil wells, and without requiring liquefaction of Natural Gas.

The first cascade, to operate at optimum pressures that are compatible with the maximum pressure drop current polymeric membranes can withstand, can operate at a relative high pressure to be efficient, but this pressure is usually lower than the pressure of the Natural Gas source, which can be extraction wells, gas pipelines or Natural Gas processing plants.

In such cases, the device reduces pressure for the input of the feed flow to the first stream through a turbo-expander, and its mechanical power is transferred to a turbo-compressor to re-inject the recycle Natural Gas depleted in Helium and other gases other than methane, which is extracted from the tail of the first cascade, in order to minimize the power consumption of the device.

Since the power delivered by the turbo-expander is usually not enough to make the turbo-compressor reinject recycle Natural Gas with the necessary pressure to reenter the source of Natural Gas, the device has, for such purposes, a second relative low power compressor to reach the required pressure in the recycle Natural Gas.

Since the operating pressure of the second cascade is lower than the operating pressure of the first stream, because the mean free path of the gas has to be similar to the pore diameter of the porous membranes, the device reduces feed pressure using a second turbo-expander, and its mechanical pressure is transferred to a turbo-compressor which reinjects, in this case Helium-4, to the first cascade, if it still has a significant methane content, or, if this content is insignificant, to inject Helium-4 into the discharge system.

If the output pressure of said turbo-compressor is not enough to feed the Helium-4 discharge system, the device has a second compressor of relative low power which allows it to reach the required pressure.

Under those conditions, it should be noted that the device allows to retrieve not only Helium-4-depleted Natural Gas as a commercial product marketable as the product from the tail of the first cascade, but also Helium-3 as a marketable product, produced by the head of the second cascade, and Helium-4 as a marketable product, produced by the tail of the second cascade, allowing, also, to remove relevant fractions of Hydrogen, Nitrogen and CO2 and other gasses present in Natural Gas from Compressed Natural Gas, through different extraction points of the first or second cascade.

Both the volumes of Helium-4 and Helium-3 produced may require treatment of extracted flows to reach the purity and concentration levels required for commercialization, but due to the relative low flows required, these devices do not require significant investments in relation to those required for cascades.

The Helium-4 produced in this device is different from present from cryogenic distillation plants which, because present plants produce Helium in liquid state, and is transferred and also transported it in liquid phase, using complex and expensive facilities for handling and transport.

With the device of this disclosure, Helium is produced as pressure Helium and it is transferred and transported through large normalized cylinders to handle compressed Helium. The Helium-3 produced by this device is also stored and transported as compressed gas, but, today, Helium-3 is also stored and transported as pressure Helium-3, as a product of the decay of Tritium.

Only those applications where both Helium-4 and Helium-3 are required in liquid state, a specific liquefaction equipment can be added for each application, without penalizing all other uses where Helium, whether Helium-3 or Helium-4, is used in gaseous form.

Given the disadvantages of the equipment presented above, this disclosure has been designed to solve those issues.

In other words, the purpose of this disclosure is to create a device for the production of Natural Gas of greater purity, by removing the Helium that is usually present in Natural Gas, and also to separate Helium isotopes from each other in the device itself, by combining polymeric and porous membranes with a high efficiency cascades design and simplified components, and, in turn, to eliminate other gasses present in Natural Gas.

Other aspects of the disclosure will be appreciated upon a reading and understanding of the following detailed description.

### BRIEF DESCRIPTION OF THE DRAWINGS

In order to have a better understanding of this disclosure, hereinafter there is a detailed description, based on the accompanying drawings, included for the sole purpose of illustrating the preferred way to implement this disclosure, without limiting the disclosure:

FIG. 1 shows a diagram of the embodiment of the disclosure, including the two cascades for the separation of Helium-3, Helium-4, and Natural Gas.

FIG. 2 shows a diagram of the first cascade of permeable membranes to separate the Helium of Compressed Natural Gas, which illustrates the recycle gas-gas injectors, and the feed turbo-expander and turbo-compressor and return to the Natural Gas source.

FIG. 3 shows a diagram of the second cascade of porous membranes to separate Helium isotopes, which illustrates the recycle gas-gas injectors, and the feed turbo-expander and turbo-compressor and return to the Natural Gas source.

### DETAILED DESCRIPTION OF THE DISCLOSURE

Before going into a detailed description, it is noted that the implementation described is not to limited to the separation of Helium isotopes from Compressed Natural Gas alone, and therefore, although this implementation is shown and described for explanation purposes as applied to the separation of Helium-3 and Helium-4 present in Compressed Natural Gas, it can be implemented to separate other isotopes of other minority lightweight gasses contained in a heavier carrier gas present in larger proportions, and, if not needed to separate the isotopes of some light gas, the device can be limited to the first cascade of separation of the light minority gas from the heavy majority gas, using the recycles and feeds and withdrawals proposed for this device, or, if the minority light gas is already separated from the heavier carrier gas, the device may be limited to separating the isotopes of the light gas, using the recycles and feeds and withdrawals proposed for this device.

This disclosure presents a new device to separate the isotopes of Helium in Compressed Natural Gas, while returning Compressed Natural Gas with concentration reduced in Helium, based on a continuous and coupled operation of two cascades operating jointly to increase, in the first cascade, the concentration of Helium in Natural Gas, and, from the depletion section of the first cascade, Compressed Natural Gas is discharged and recovered with concentration reduced in Helium, while the second cascade, fed by the flow with higher Helium-enrichment from the first cascade, separates the isotopes of Helium-3 and Helium-4, discharging the Helium-3 from the section with greater Helium-3 enrichment in the second cascade, while Helium-4 is discharged from the section with less Helium-3 content from the second cascade.

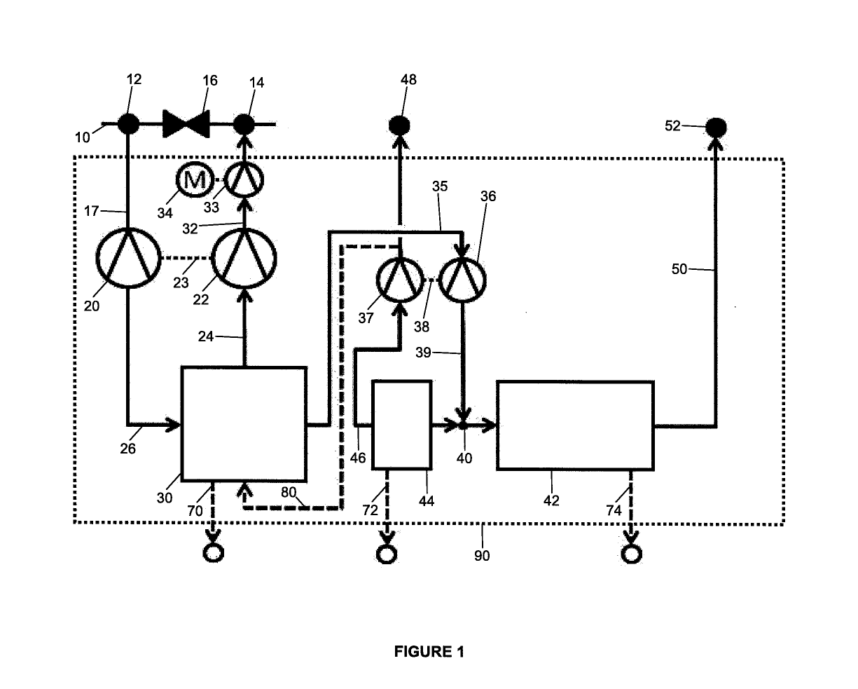

FIG. 1 illustrates a schematic view of the proposed device, which processes a source of Natural Gas at pressure with a certain content of Helium that wants to be removed, outlined as a feed line (10), which can be a downstream pipeline, a downstream Natural Gas well, or a Natural Gas processing plant, down-streamed as schematically shown in (12), where the return of the Helium-depleted Compressed Natural Gas is produced by the connection section (14), where a restriction is shown (16), placed for illustration purposes as a closed valve, to shows that when connecting the proposed device to the source of Natural Gas, caution shall be taken to avoid mixing the Helium-depleted current of connection (14) with the Helium current of connection (12). The line feeding (17) of the device drives the flow towards the turbo-expander (20), which moves a turbo-compressor (22) through a shaft (23) that transfer the mechanical power produced in the turbo-expander (20) to the turbo-compressor (22), which drives the return line of Natural Gas (24), with the Helium-depleted Natural Gas produced by the proposed device.

The downstream from the turbo-expander (20) is driven through the feed line (26) to the first cascade of permeable membranes (30), which shall preferable be polymeric membranes, given the current technologies available.

The turbo-expander (20) is necessary when, as usual, the pressure from the Natural Gas source (10) is higher than the pressure required for optimum operation of the first stream (30).

The output of the return, Helium-depleted, Natural Gas (24), after going through the output turbo-compressor (22) may have a pressure lower than the pressure required to inject it again into the source of Natural Gas (10). In this case, exit (32) of the turbo-compressor (22) has a second compressor (33), which is driven by the motor (34), and discharges through the connection (14) in the Natural Gas line (10), and therefore becomes a line with its Helium-depleted Natural Gas.

Because the line of Helium-enriched gas (35) produced by the first cascade (30) has a pressure higher than the optimal pressure at which a cascade must operate to separate helium isotopes, it reduces pressure through a turbo-expander (36), that moves a turbo-compressor (37) through the shaft (38) that transmits the mechanical power produced by the turbo-expander (36) to the turbo-compressor (37). The downstream from the turbo-expander (36) is driven towards the second cascade through the line (39) connecting the Helium-enriched gas with the flow that is circulating through the second cascade, in the feed point (40).

Since the second source has membranes suitable for isotope separation, and given the attainable separation factors to separate Helium isotopes, it has both a part of the cascade generating Helium-3 enrichment, also called section of enrichment of the cascade, shown in the figure schematically as block (42), and a part of the cascade for the depletion of Helium-3, also called section of depletion, shown in the figure schematically as block (44).

With the technologies currently available, it is convenient for membranes of the second cascade to be porous membranes.

The profile and operation of the second cascade, consisting of the enrichment section (42) and the depletion section (44), is designed so that the feed point (40) has a minimum difference in enrichment between the currents that are mixed in the feed point (40).

If the cascade zone with lower Helium-3 enrichment of the depletion section is referred to as a “tail”, and the cascade zone of higher enrichment in Helium-3 from the enrichment section is referred to as a “head”, then the tail of the second cascade (44) comes from the extraction line of minimum enrichment in Helium-3 (46), the corresponding higher enrichment in Helium-4, which corresponds due to its properties with the Helium that is currently on the market, so that the outflow (48) may be marketed as compressed Helium after increasing its pressure with the turbo-compressor (37).

Because the discharge pressure required to fill normalized cylinders to store and transport Helium is much higher than the usual pressure of Natural Gas sources, the output pressure of Helium exiting the turbo-compressor (37), available at the point of extraction (48) it is not enough to fill normalized cylinders, and a second compressor not shown in FIG. 1 must be added, which is not included because it is a commercial product with no special features and connections, and not part of the proposed device.

The head of the second cascade (42) produces in its extraction line with higher Helium-3 enrichment (50), which is discharged through the connection (52). The purification equipment and increase in concentration that may be required to market the gas with maximum Helium-3 enrichment of the output (52), is not shown in FIG. 1, and since their flows and sizes are extremely low, they do not strictly require continuous production, are not shown in FIG. 1, and are not part of the proposed device.

Other gases, such as Nitrogen, CO₂ and Hydrogen, among others, which can also be found in the source of Natural Gas, depending on the separation factors of the two cascades for each of these gases, may also be extracted at points close to the heads and tails of each stream depending on the gases and membranes, as shown generically as extractions (70) (72) and (74), of which only extraction is shown for each section of the streams (30) (42) and (44) for simplicity purposes, but each stream can have more than one intermediate point of gases extraction, so as to improve the purity of the three main productions of the device, Helium-depleted Natural Gas (14), Helium-4-enriched Natural Gas (48) and Helium-3-enriched Natural Gas (52).

If the extraction form the head of the first cascade (35), due to its design and optimization still has a substantial Methane content that needs to be recovered, the extraction from the tail of the second cascade, since it has membranes that separate gases due to the difference in molecular weights, also causes these more methane-enriched concentrations to exit through the tail (46), and therefore it may be convenient for the extraction from the tail of the second cascade to be recycled into the first cascade at some intermediate point of the first cascade, instead of feeding the helium charging system (48), generically shown as the dotted line (80), to minimize the energy consumption of the stream and, in that case, the extraction of Helium-4 and subsequent re-compression shall be through some intermediate extractions of the depletion section (44) of the second cascade, for instance, the intermediate extraction (72).

Line (90) outlines the limit that defines the proposed device in accordance with this disclosure.

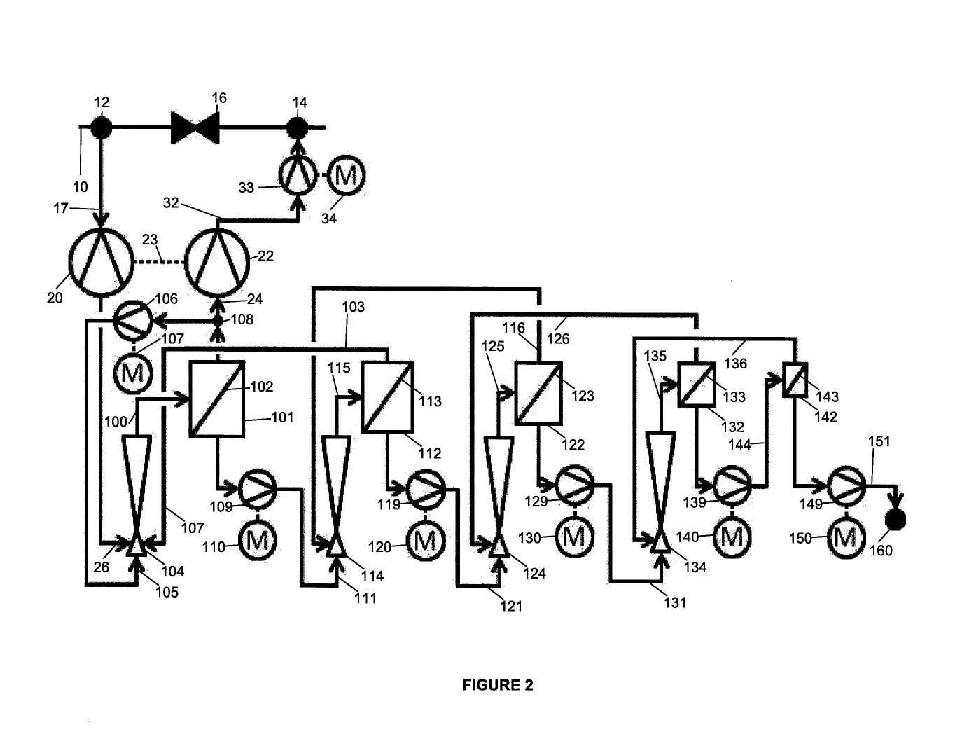

FIG. 2 contains a schematic view of the first cascade that makes up the proposed device, processing a source of Natural Gas with a certain content of the Helium that is intended to be removed, schematized as a feed line (10), with the turbo-expander (20) and the turbo-compressor (22) system, with an output compressor (33) already explained in FIG. 1.

The first cascade is displayed in this figure as composed of five stages for illustration purposes, but more or less stages can be used, depending on the Helium separation factor sought at this cascade, and the general economy of the device, but always maintaining the design explained below. After the turbo-expander (20), the Natural Gas source feed is through line (26), entering through feed line (100) to the first stage (101), with the membranes outlined as the barrier (102), and where the feed (26) is combined with the non-permeated recycle of the subsequent stage (103), through a gas-gas injector (104), with the flow as driving fluid (105) coming from the non-permeated flow of the same stage (102) that is extracted with the compressor (106), that is driven by the engine (107) that gets its flow from derivation (108) that separates the recycled flow that is not sent as recovered Helium-depleted Natural Gas (24) to the Natural Gas source, where the drive flow (105) aspires when the non-permeated recycle flow of the subsequent stage accelerates (103) and the feed flow from the first cascade (26) to then increase the pressure at the gas-gas injector outlet diffuser (104), shown for illustration purposes only as composed by a convergent piece and a divergent piece.

The compressor (109), driven by a motor (110), extracts the diffused material of stage (101) through the membranes (102) and injects it through the feed line (111) to the second stage (112), composed of membranes (113), after passing through a second gas-gas injector, outlined as (114) for illustration purposes, which is discharged into the input line (115) to stage (112), after combining with the non-permeated recycle (116) of the subsequent stage, where the engine fluid is flow (111) from the compressor (109).

All intermediate stages follows the same design of the previous stage; in the case of the third stage, the compressor (119), driven by a motor (120) extracts the diffused material of stage (112) through the membranes (113) and injects it through the feed line (121) to the third stage (122), composed of membranes (123), after passing through a gas-gas injector, outlined as (124) for illustration purposes, which is discharged into the input line (125) to stage (122), after combining with the non-permeated recycle (126) of the subsequent stage, and where the engine fluid is flow (121) from the compressor (119).

The same for the fourth state, the compressor (129), driven by a motor (130), extracts the diffused material of stage (122) through the membranes (123) and injects it through the feed line (131) to the fourth stage (132), composed of membranes (133), after passing through a third gas-gas injector, outlined as (134) for illustration purposes, which unloads into the input line (135) to stage (132), after combining with the non-permeated recycle (136) of the subsequent stage, and where the motive fluid is the flow (131) from the compressor (129).

Since the explanation is carried out on a cascade with five stages, the last stage does not follow the scheme explained for stages 1 through 4, but is fed directly through the compressor (139) driven by a motor (140) that feeds the last stage (142), composed of membranes (143) directly through the line of injection (144).

The output flow of the last stage is extracted by the compressor (149), driven by a motor (150), and injects the output gas (151) to the point of connection of the output withdrawal (160) Helium-enriched and Methane-depleted.

As shown in FIG. 2, the proposed device carries out all non-permeated recycles of subsequent stages without using a turbo-compressor, but using gas-gas injectors (106) (114) (124) and (134) it manages to feed all recycles of subsequent stages (105) (116) (126) and (136) without using mobile parts, modified turbo-machines and additional seals.

In this scheme heat exchangers have been omitted, necessary at each stage of compression for the purposes of removing the compression work of the engines, so as to simplify the explanation of FIG. 2.

In another alternative configurations of this device, when it is not convenient to send all the Helium-enriched flow to the second cascade, the fraction of the flow not sent to the second cascade can be recycled, adding a gas-gas injector between the compressor (139) and the last stage (142), and where the driving flow is the flow from the compressor (139), so that the last stage would have the same components as the preceding stage, which is why it is not shown in FIG. 2, and thus simplify the explanation of the first cascade.

For the purposes of being clear as to how to implement this alternative in the proposed device, the extraction of most Heilum-3-enriched material through the end of the second cascade shall be made including the option of extracting only a fraction of the flow that goes through the membranes in the last stage, so as to detail both extraction alternatives of the flow more enriched at the ends of any of the two cascades for the proposed device.

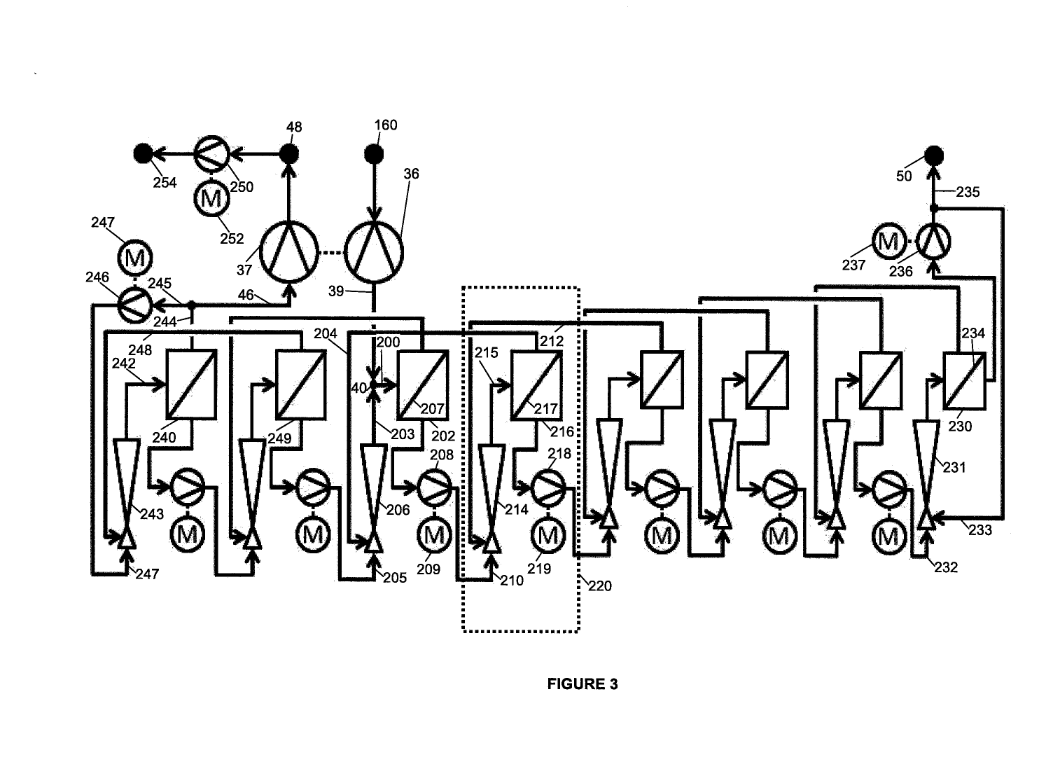

FIG. 3 illustrates a schematic view of the second cascade that makes up the proposed device, processing Helium-enriched gas from the first cascade, with its Helium isotopes separated on this second cascade, and feeding outlined as injection point (160), with its pressure reduced by the turbo-expander (36), which drives the turbo-compressor (37), already explained in FIG. 1.

The second stream is displayed in this figure as composed by eight stages for illustration purposes, in which 6 stages are displayed, making the section of Helium-3 enrichment, while the two remaining are displayed making the section of Helium-3-depletion or Helium-4 enrichment, with the option to use more or less stages depending on the factor of separation of Helium of each stage, the separation gain expected in the second cascade, and the general economy of the device, and only this number of stages have been placed for illustration purposes, so that the device used in the practice will use more or less stages depending on the specific design, but always keeping the concept of connections and design detailed below. The discharge of the turbo-expander (36) is driven to the second stream through line (39) which connects Helium-enriched gas that is obtained at the first cascade with the flow that is circulating through the second cascade, at the feed point (40), forming the feed flow (200) entering the first stage (202) of the enrichment section of the cascade, after mixing with the flow (203) from the mix of non-diffused recycle of the subsequent stage (204) of the enrichment section of the cascade, along with forwarding from the previous stage (205) in the depletion section of the cascade.

The mixing of flows (204) and (205) is carried out through the gas-gas injector (206), similar to the one described for gas-gas injectors in the first cascade in FIG. 2, and where the motive flow is the forwarding flow of the previous stage (205).

Once the output flow (203) of the injector (206) and the feed flow (39) enter the first stage (202), to spread the gas through the porous membranes (207), the gas spread, enriched in Helium-3 is driven by the compressor (208) towards the subsequent stage, with the motor's driving power (209).

This Helium-3 enriched flow (210), after joining the non-diffused recycle current of the subsequent stage (212), in the gas-gas injector (214), form the input flow (215) to stage (216), so that the flow diffusing through membranes (217) increases its Helium-3 enrichment and circulates to the subsequent stage driven by the compressor (218) due to the engine's driving force (219).

As schematically shown with the dotted line (220), the set described by stage (216), membranes (217), gas-gas injector (217), compressor (218) and motor (219), are part of a set that is repeated functionally towards the higher enrichment flows to form the enrichment section of the cascade, and also repeated towards lower enrichment units to form the depletion section of the cascade, except the last stage (230) or head of the stage, since it lacks recycle from a subsequent phase, the feed gas-gas injector (231), is driven by the driving flow from the previous stage (232), and recycles the flow (233) coming from the flow that circulates through the membranes (234), but not derived as extraction flow of highest Helium-3-enrichment (235), which is generated by the extraction made by the compressor (236), that is driven by the motor (237), to extract the Helium-3-enriched flow by pressure through the extraction point (50) of the second cascade of the proposed device.

The stage of less Helium-3 enrichment is also different to the repetition of the various functional units, in the last stage or tail of the cascade, since it lacks a prior stage providing the driving flow for the gas-gas injector. This is the reason why the stage of less Helium-3 enrichment (240), enters the flow (242) that comes from the gas-gas injector (243) which mixes the non-diffused flow (244) of stage (240) which has not been derived to the discharge system through line (46) which feeds the output compressor (37), forming the flow (245) which is driven by the compressor (246) through the motor's driving power (247), to act as the motive flow (247) of the injector (243) and suck the non-diffused recycle (248) of the subsequent stage (249).

The volume extracted by the turbo-compressor (37) feeds the point of extraction of cascade (48) corresponding to the lowest Helium-3 content or Helium-4-enriched content, which can be loaded as Helium by pressure in standardized transport and storage cylinders, not shown in FIG. 3, but with loading pressure schematically achieved with compressor (250), which is driven by the driving force of the motor (252) so that the pressure Helium cylinders can be connected to the schematic load point (254) for storage and transportation.

Heat exchangers are omitted in this scheme, necessary at each stage of compression for the purposes of removing the compression effort of the engines, so as to simplify the explanation of FIG. 3.

Another option for the design of this device, when it is not convenient that only fraction (235) of the flow diffused at stage (230) is sent to the extraction point (50), since the device sends the other part of the diffused flow of stage (230) as flow (233) of recycle to the same stage (230), but it is convenient to send to the point of extraction (50) all of the flow diffused towards the point of extraction (50), so the recirculation line (233) has a null flow, and in this case, for the proposed device, the gas-gas injector is not necessary (232) and the line of the flow (232) can be discharged directly at stage (230).

Just like the proposed device has the option of sending all of the higher Helium-3 enrichment diffused flow from stage (230) of the cascade head or not, towards the point of extraction, as explained, the proposed device has a similar alternative for the non-diffused recycle with less Helium-3 enrichment from stage (240) of the tail of the cascade.

In another design alternative for this device, when it is not convenient to send only the flow (46) towards the point of extraction (48) because the non-diffused flow (244) of the last stage (240) of the tail of the second cascade, the fraction of flow (245) is extracted to recycle on the same stage (240), gas-gas injector (243) is not necessary, because there is no need to mix two recycles, (247) and (248), before entering phase (240). For that design alternative of the proposed device, the bypass (245) of the flow (244) is not required, and all the flow (244) is directed through the line (46) to the compressor (37) and then the compressor is not necessary (246), nor is its motor (247), or the gas-gas injector (243), and the recycle of the non-diffused material (248) of the subsequent stage (249) enters stage (240) through an additional compressor not shown in the figure.

What is claimed is:

1. A device for the removal and separation of helium isotopes from natural gas, to separate isotopes from a first gas, in relation to a second majority carrier gas at pressure, with higher molecular weight than the isotopes of the first gas, with increased commercial value when the content of the first gas decreases in the second majority carrier gas, comprising two cascades with serial stages each, with the first cascade operating at a pressure that is equal or lower to the pressure of the source providing the majority carrier gas, and allows enrichment of the content of the first gas in relation to the second majority carrier gas through selective permeability of the mixture of gasses, which, when going through successive membrane stages with higher permeability to the first gas in relation to the second majority carrier gas, a flow can be extracted of the majority carrier gas as output of the first cascade, with depletion of the content in the first gas, generating a first continuous flow of a product of commercial interest, while the second output of the first stream is enriched in the content of the first gas and feeds the second cascade at some intermediate point, and where this second cascade is at a pressure lower than the pressure operating the first cascade, to produce isotope separation of its gasses through diffusion of that gas through inert porous membranes, since the mean free paths of the gas of the second cascade is similar to the pore radius of the porous membranes, generating higher permeability for molecules and isotopes with lower molecular weight, so that at the end of the second cascade towards where gasses advance with lower molecular weight, an output flow is obtained enriched with the light isotope, generating in this flow a second continuous flow of a product of commercial interest, while at the other end of the second cascade in relation to the extraction point of the output enriched with the lighter isotope and the feed point, an output flow is obtained depleted in the light isotope, which generates a third continuous flow of a product of commercial interest.

2. The device for the removal and separation of helium isotopes from natural gas of claim 1, wherein the two cascades make mixtures prior to entering a stage of the non-diffused and non-permeated recycles of the subsequent stages with flows diffused and permeated from prior stages, and the flows of the same stages when they have output flows fully or partially recirculated to form the flow entering that stages, through gas-gas injectors, where the driving flow is the flow with lower pressure that must be mixed, and receives the pressure necessary to operate as motive flow of the gas-gas injector of a specific compressor for each gas-gas injector.

3. The device for the removal and separation of helium isotopes from natural gas of claim 2, wherein the reduction of pressure necessary for the output enriched with the content of the first gas to enter with the proper pressure as feed for the second cascade, through a turbo-expander with useful power in the shaft, used to drive a turbo-compressor which increases the output pressure of the gas depleted in the light isotope produced in the second cascade.

4. The device for the removal and separation of helium isotopes from natural gas of claim 3, wherein the reduction of pressure required from the source of the majority carrier gas and the feed of the first cascade is through a turbo-expander with useful power in the shaft used to drive a turbo-compressor that increases the output pressure of the majority carrier gas depleted in the content of the first gas that is produced in the first cascade.

5. The device for the removal and separation of helium isotopes from natural gas of claim 3, wherein the output gas depleted in the light isotope produced in one of the ends of the second cascade have a substantial content of the majority carrier gas, and the output of the turbo-compressor which increases its output pressure, is connected at some intermediate stage of the first cascade as recycle flow to be aspired by the gas-gas injector with motive flow being the flow with the concentration that is more similar in content to the lightweight gas, and where extraction of the flow for depletion of the light isotope and the majority carrier gas occurs between an intermediate stage of the entering the feed flow and the end of the second cascade, which was sent by the turbo-expander as recycle to the first cascade.

6. The device for the removal and separation of helium isotopes from natural gas of claim 4, wherein an output of gas depleted in the light isotope produced in one of the ends of the second cascade with a substantial content of the majority carrier gas, and the output of the turbo-compressor which increases its output pressure connected at some intermediate stage of the first stream as flow of the recycle to be aspired by the gas-gas injector with drive flow being the concentration that is more similar in content to the lightweight gas, and where extraction of the depleted flow of the light isotope and the majority carrier gas occurs between an intermediate stage of the entering the feed flow and the end of the second cascade, which was sent by the turbo-expander as recycle to the first cascade.

7. The device for the removal and separation of helium isotopes from natural gas of claim 5, wherein the membranes of the first cascade are polymeric membranes.

8. The device for the removal and separation of helium isotopes from natural gas of claim 6, wherein the membranes of the first cascade are polymeric membranes.

9. The device for the removal and separation of helium isotopes from natural gas of claim 7, wherein the light gas is Helium and the majority carrier gas is Methane.

10. The device for the removal and separation of helium isotopes from natural gas of claim 8, wherein the light gas is Helium and the majority carrier gas is Methane.

11. The device for the removal and separation of helium isotopes from natural gas of claim 7, wherein the light gas is Helium, and the majority carrier gas is Methane mixed with other gases which can also be extracted from various stages of both from the first and the second cascade of the device.

12. The device for the removal and separation of helium isotopes from natural gas of claim 8, wherein the light gas is Helium, and the majority carrier gas is Methane mixed with other gases which can also be extracted from various stages of both from the first and the second cascade of the device.

13. The device for the removal and separation of helium isotopes from natural gas of claim 2, wherein the device only has the first cascade, and does not separate the isotopes of the first gas.

14. The device for the removal and separation of helium isotopes from natural gas of claim 13, wherein the reduction of pressure necessary for the output enriched with the content of the first gas to enter with the proper pressure as feed for the second cascade, through a turbo-expander with useful power in the shaft, used to drive a turbo-compressor which increases the output pressure of the gas deployed in the light isotope produced in the second cascade.

15. The device for the removal and separation of helium isotopes from natural gas of claim 14, wherein the membranes of the cascade are polymeric membranes.

16. The device for the removal and separation of helium isotopes from natural gas of claim 15, wherein the light gas is Helium and the majority carrier gas is Methane.

17. The device for the removal and separation of helium isotopes from natural gas of claim 14, wherein the light gas is Helium and the majority carrier gas is Methane mixed with other gases that can be extracted at different stages of the cascade.

18. The device for the removal and separation of helium isotopes from natural gas of claim 2, wherein the device only has the second cascade, and the feed is from a pressure source of the first gas.

19. The device for the removal and separation of helium isotopes from natural gas of claim 3, wherein the device only has the second cascade, and the feed is from a pressure source of the first gas.

20. The device for the removal and separation of helium isotopes from natural gas of claim 19, wherein the light gas is Helium and the majority carrier gas is Methane.

21. The device for the removal and separation of helium isotopes from natural gas of claim 19, wherein the light gas is Helium and the majority carrier gas is Methane mixed with other gases that can be extracted at different stages of the cascade.
